(19) United States
(12) Patent Application Publication
(10) Pub. No.: US 2006/0177280 A1
(43) Pub. Date: Aug. 10, 2006

(54) Fluidizing unit for a powder conveyor and powder conveyor with fluidizing unit

(76) Inventors: Leopold Von Keudell, Salem (DE); Rene Schmid, Hinterforst (CH); Daniel Ziwica, Arbon (CH); Pierre Plascar, Rebstein (CH)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/337,429

(22) Filed: Jan. 23, 2006

(30) Foreign Application Priority Data
Jan. 26, 2005 (DE) 20 2005 001 307.2

(51) Int. Cl. B65G 53/40

(52) U.S. Cl. 406/134

(57) ABSTRACT

The fluidizing unit for a powder conveyor has a powder suctioning opening, a powder suctioning canal and a fluidizing ring, which is arranged above the powder suctioning opening and concentrically to the powder suctioning canal. Moreover the fluidizing unit has fixing means, which are developed in a way that they hold the fluidizing ring such that the outer surface area of the fluidizing ring remains at least partially free.

### TECHNICAL FIELD

The invention relates to a fluidizing unit for a powder conveyor and a powder conveyor for conveying powder required for coating with a fluidizing unit. In order to be able to convey the powder required for coating—which hereinafter shall be called powder in short—more easily from a powder storage reservoir, the powder conveyor is equipped with a fluidizing unit. The fluidizing unit is arranged at the end of the powder suctioning pipe of the powder conveyor and blows fluidizing air into the powder reserve in the suction area of the powder suctioning pipe so that the powder is fluidized and as a result is more easily suctioned and transportable.

### BACKGROUND OF THE INVENTION

A powder conveying device with a fluidizing unit is known from the state of the art U.S. Pat. No. 6,398,462 B1. The powder conveyor described there has a powder suctioning pipe, at whose inlet-side end the fluidizing unit is arranged. This unit includes a fluidizing ring consisting of a porous, air-permeable material, through which fluidizing air is blown directly at the inlet of the powder suctioning pipe into the powder. The fluidizing ring has a conical area for this purpose on its inside, through which the fluidizing air escapes from the fluidizing ring. While the powder suctioning pipe covers the inner shell side of the fluidizing ring, the outer surface area of the fluidizing ring is surrounded by an airtight locking housing, which is simultaneously used for the holding the fluidizing ring. The fluidizing air is consequently forced to escape on the conical inside of the fluidizing ring. However the described fluidizing unit has the disadvantage that only the part of the powder, which is directly below the powder suctioning opening, is fluidized. This can lead to the fact that the part of the powder reserve, which laterally surrounds the powder suctioning pipe, does not continue flowing or does not sufficiently continue flowing to the powder suctioning opening. In order to counteract that, the fluidizing air quantity must be then increased, what leads to a reduction of the powder suctioning capacity of the powder conveyor, because more fluidizing air is sucked in.

A powder conveying device with a fluidizing unit is also known from the state of the art DE 295 18 478 Ul. The fluidizing unit is arranged at the end of the powder conveying head immersed into the powder reserve. In operation, the fluidizing air flows through a porous disk and escapes from the area of the porous disk. The powder suctioning openings, however, are in the upper area of the powder conveying head and as a result arranged above the fluidizing disk. Such an embodiment has the disadvantage that as soon as the powder reserve in the powder storage reservoir sinks below a certain level, no more powder can be sucked in from the powder conveyor, because the powder suctioning openings at the powder suctioning head are not arranged sufficiently far below.

### SUMMARY OF THE INVENTION

An object of the invention is to provide a fluidizing unit for a powder conveyor and a powder conveyor with fluidizing unit with which a sufficiently large quantity of powder can also be fluidized with a low fluidizing airflow.

With the embodiment of the fluidizing unit according to the invention, a big umbrella-shaped fluidizing of the powder can be reached, what on the other hand leads to an even and homogeneous fluidizing of the powder in and around the area of the powder suctioning opening. In that way, relatively lot of powder is fluidized with relatively less fluidizing air.

Advantageously it can be achieved, using the fluidizing unit according to the invention, that the powder conveyor still smoothly conveys the powder even on the base of the powder storage reservoir.

The object is solved by a fluidizing unit for a powder conveyor with the characteristics according to claim 1.

The fluidizing unit according to the invention for a powder conveyor has a powder suctioning opening, a powder suctioning canal and a fluidizing ring, in which case the fluidizing ring is arranged above the powder suctioning opening and concentrically to the powder suctioning canal. Moreover the fluidizing unit has fixing means for holding the fluidizing ring, which are developed in a way that the outer surface area of the fluidizing ring remains at least partially free.

In addition, the object is solved by a powder conveyor for conveying coating powder with the characteristics according to claim 9 together with the characteristics stated above.

Advantageous further developments of the invention result from the characteristics stated in the dependent claims.

In a first further development of the fluidizing unit according the invention for a powder conveyor, the fluidizing unit has an air-permeable material.

In a second further development of the fluidizing unit for a powder conveyor, an annular fluidizing air canal is provided, to which the fluidizing ring connects on the outlet side. This ensures that the fluidizing ring is evenly supplied with fluidizing air.

Advantageously the fixing means of the fluidizing unit according to the invention for a powder conveyor have an annular stopper and a crown, between which the fluidizing ring is arranged.

Furthermore it is of advantage, if the crown has several spacers in the fluidizing unit according to the invention. This prevents that the packaging foil, in which the powder reserve is kept, is suctioned.

In another embodiment of the fluidizing unit according to the invention, it is provided that the crown can be screwed on the powder suctioning canal. This has the advantage that the fluidizing ring can simply be replaced by first unscrewing the crown from the powder suctioning canal and subsequently removing the fluidizing ring.

According to another characteristic of the invention, the fluidizing ring can include several segments. As a result the crown must not be completely unscrewed in order to be able to replace the fluidizing ring, but it suffices to loosen the crown a bit. Then the individual segments of the fluidizing ring can be pulled out laterally.

Furthermore it is of advantage, if in the case of the fluidizing unit according to the invention for a powder conveyor, the crown has the powder suctioning openings.

Finally, the powder conveyor according to the invention can have a powder injector working with compressed air for conveying coating powder.

### BRIEF DESCRIPTION OF THE DRAWINGS

These and other aspects of the invention are apparent from and will be elucidated in details with reference to two figures described hereinafter.

FIG. 1 shows an embodiment of the powder conveyor for conveying coating powder in a three-dimensional view.

FIG. 2 shows a possible embodiment of the fluidizing unit for the powder conveyor in the cross-section.

### DETAILED DESCRIPTION OF THE INVENTION

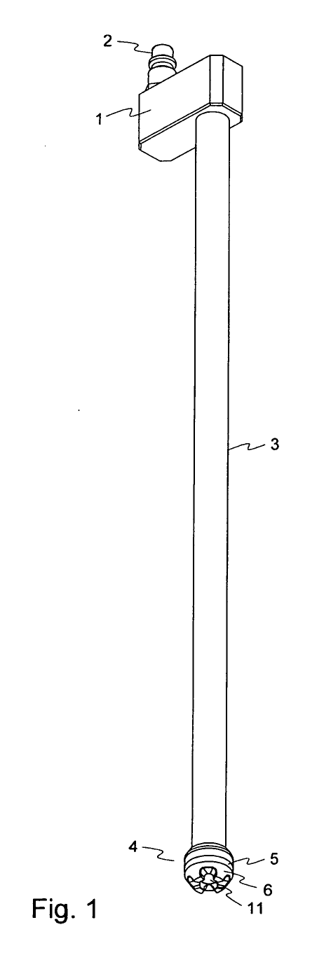

FIG. 1 shows a possible embodiment of the powder conveyor in a three-dimensional view. An injector 1, which is supplied with conveying air and dosage air through a coupling 2, conveys the powder from a reservoir—not shown in FIG. 1—with help of the conveying air through a conveying pipe 3 to a powder spray gun also not shown in FIG. 1. Moreover the hose necessary for conveying the powder to the powder spray gun is connected through the coupling 2. A fluidizing unit 4 is provided at the upstream end of the powder conveying pipe 3, the fluidizing unit 4 providing for a sufficient fluidizing of the powder existing in the powder storage reservoir. The fluidizing unit 4 includes a fluidizing ring 5, through which the fluidizing air is led into the powder container. A crown 6 connects to the fluidizing ring 5, which has a powder suctioning opening 11 inside.

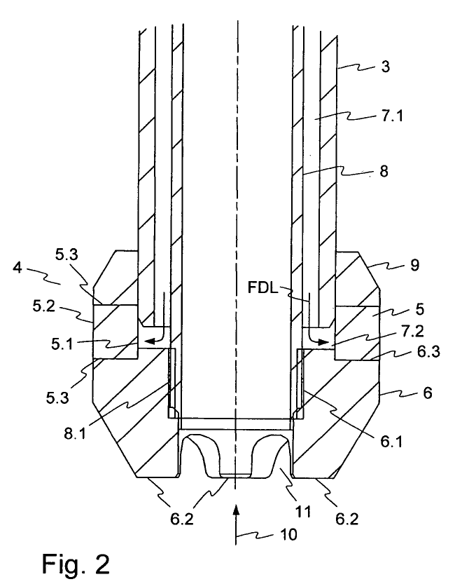

The upstream end of the powder conveying pipe 3 and the fluidizing unit 4 are represented in a section in FIG. 2. Inside the conveying pipe 3 is a powder pipe 8 arranged concentrically to the conveying pipe, in which the powder is conveyed from the powder storage reservoir in the direction of injector 1. The powder pipe 8 is also called powder suctioning canal in the following. In the embodiment shown in FIG. 2 an annular cap 9, which serves as upper stopper for the fluidizing ring 5, is fastened on the upstream end of the conveying pipe 3. The crown 6 is unscrewed on the powder pipe 8 so that the fluidizing ring 5 is fixed between the cap 9 and the crown 6. In order to be able to unscrew the crown 6 on the powder pipe 8, the powder pipe 8 has a male thread 8.1 and the crown 6 has a female thread 6.1. The crown 6 has a shoulder 6.3 at the upper end in order to align the fluidizing ring 5 vis-à-vis the crown 6. Moreover the crown 6 has several spacers 6.2, which prevent that the packaging material, for example the packaging foil, in which the powder is kept, is suctioned by the powder conveyor. The arrow 10 marks the direction of flow of the suctioned powder. The first section of a fluidizing air canal 7.1 is located between the conveying pipe 3 and the powder pipe 8. The second annular section of the fluidizing air canal 7.2 connects to it downstream. The arrows mark the direction of flow of the fluidizing air FDL in the fluidizing air canal. In operation the fluidizing air FDL enters into the fluidizing ring through the inner surface area 5.1 of the fluidizing ring 5 and again escapes from the outer surface area 5.2 from the fluidizing ring 5. The two areas 5.3 of the fluidizing ring 5 do not contribute in the embodiment shown in FIG. 2 to the fluidizing, but are rather clamped between the cap 9 and the crown 6.

The fluidizing ring 5 has an air-permeable material. It can be produced from air-permeable synthetic material, as for example polyethylene, in sintering process or consists of porous structures from metal balls with hollow spaces or has one of these materials. The fluidizing ring 5 can also be composed of several segments.

The arrangement of the fluidizing ring 5 above the powder suctioning opening 11, as this is shown in FIG. 2, supports the development of an umbrella-shaped fluidized powder area.

The spacers 6.2 of the crown 6 have also the advantage that a simple, oblong tool, for example a screwdriver, can be put into the recesses between the spacers 6.2, with whose help the crown 6 can be then unscrewed without great effort.

The preceding description of the embodiments according to the present invention is used only for illustrative purposes and not for the purpose of restricting the invention. Different alterations and modifications are possible within the framework of the invention without leaving the scope of the invention and its equivalents.

### LIST OF REFERENCE SYMBOLS

1 Injector
2 coupling
3 Conveying pipe
4 Fluidizing unit
5 Fluidizing ring
5.1 Inner surface area
5.2 Outer surface area
5.3 Area
6 Crown
6.1 Thread
6.2 Spacer
6.3 Shoulder
7.1 First section of a fluidizing air canal
7.2 Second section of a fluidizing air canal
8 Powder pipe
8.1 Thread
9 Cap
10 Direction of flow of the powder
11 Powder suctioning opening
FDL Fluidizing air

1. A fluidizing unit for a powder conveyor,
with a powder suctioning opening, a powder suctioning canal and a fluidizing ring, which is arranged above the powder suctioning opening and concentrically to the powder suctioning canal, and
with fixing means for holding the fluidizing ring, which are developed such that the outer surface area of the fluidizing ring remains at least partially free.

2. The fluidizing unit according to claim 1, wherein the fluidizing ring has an air-permeable material.

3. The fluidizing unit according to claim 1, with an annular fluidizing air canal, to which the fluidizing ring connects from outlet side.

4. The fluidizing unit according to claim 1, wherein the fixing means have an annular stopper and a crown, between which the fluidizing ring is arranged.

5. The fluidizing unit according to claim 4, wherein the crown has several spacers.

6. The fluidizing unit according to claim 4, wherein the crown can be screwed on to the powder suctioning canal.

7. The fluidizing unit according to claim 1, wherein the fluidizing ring includes several segments.

8. The fluidizing unit according to claim 4, wherein the crown has powder suctioning opening.

9. A powder conveyor for conveying coating powder, which includes the fluidizing unit according to claim 1.

10. The powder conveyor according to claim 9, with an injector working with compressed air, to which the powder suctioning canal is connected.
